(19) United States
(12) Patent Application Publication
(10) Pub. No.: US 2016/0106629 A1
(43) Pub. Date: Apr. 21, 2016

(54) BIONIC PACIFIER

(71) Applicant: Yixin JIANG, Shenzhen, Guangdong (CN)

(72) Inventor: Yixin Jiang, Shenzhen, Guangdong (CN)

(21) Appl. No.: 14/647,666

(22) PCT Filed: May 4, 2014
(86) PCT No.: PCT/CN2014/076707

§ 371 Date: May 27, 2015

(30) Foreign Application Priority Data
Jul. 2, 2013 (CN) 201310272375.9
Jul. 2, 2013 (CN) 201320387211.6

(51) Int. Cl. A61J 11/00

(52) U.S. Cl. CPC A61J 11/0015; A61J 11/002

(57) ABSTRACT

A bionic pacifier (1), comprising a head part having an arched surface and a plurality of I-shaped openings (10) disposed on the arched surface circumferentially, wherein the openings (10) extend along the radial direction of the head part and the extension lines of the openings (10) intersect at the center of the head part. The bionic pacifier (1) will reduce the probability of choking for a user when he/her uses a conventional pacifier.

### FIELD OF THE INVENTION

This present invention relates to the technical field of baby products, particularly to a bionic pacifier.

### BACKGROUND OF THE INVENTION

At present, the pacifier on the market is provided with an opening which is round or cross-shaped and disposed at the center of the top of the pacifier. When a user sucks liquid through a pacifier with such a configuration, the liquid will rush through the opening and to the throat of the user directly, possibly causing the user to choke.

### SUMMARY OF THE INVENTION

The present invention provides a bionic pacifier, which can overcome the disadvantages of the prior art, avoid a direct-flow milk feeding way with single opening of the conventional pacifier and reduce the probability of choking for a user.

The technical solution to solve the above technical problem is provided as follows.

Disclosed is a pacifier, comprising a head part having an arched surface and a plurality of I-shaped openings disposed on the arched surface circumferentially, wherein the openings extend along the radial direction of the head part and the extension lines of the openings intersect at the center of the head part.

In one embodiment, the openings are disposed circumferentially, deviating from the center of the head part.

In one embodiment, the openings are disposed uniformly.

In one embodiment, the number of the openings is no less than three.

In one embodiment, the openings are closed in a natural state and open when the user is sucking the pacifier.

Compared to the prior art, the present invention has the following beneficial effects:

The invention provides a pacifier with a plurality of openings disposed circumferentially, which simulates the principle of breast milk ejection and applies a design of multiple breast milk ejection holes which are open and closed naturally. With the pacifier of present invention, the liquid will flow out through the outer portions of the head part of the pacifier diffusely, so as to prevent the liquid from flowing through the central portion of the traditional pacifier to rush to the throat of a baby directly. Thus, the probability of choking for the baby can be reduced.

The present invention is further illustrated below with reference drawings.

### BRIEF DESCRIPTION OF THE DRAWINGS

FIG. 1 is a top view of the pacifier of the present invention.

FIG. 2 is a front view of the pacifier of the present invention.

FIG. 3 is a schematic diagram of the pacifier of the present invention in a use state.

### BRIEF DESCRIPTION OF THE PREFERRED EMBODIMENTS

The present invention will be further illustrated below with reference the embodiment(s) and drawings.

### Embodiment 1

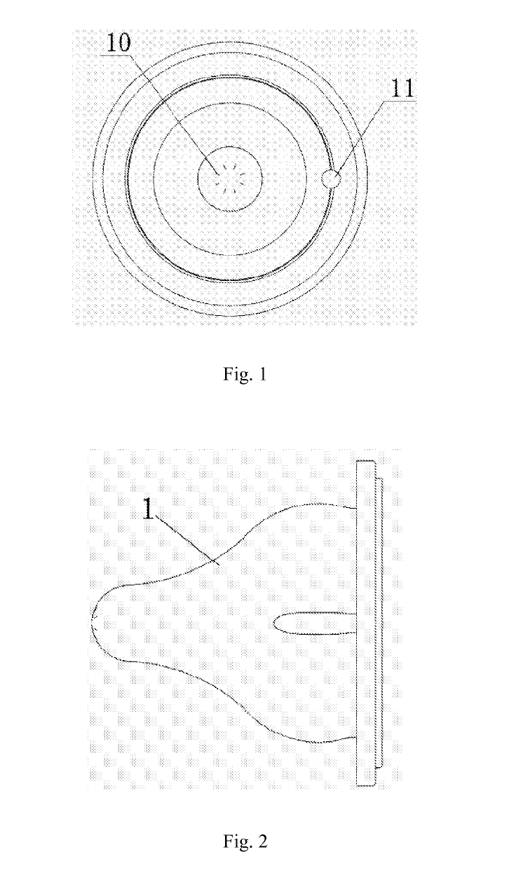

As is shown in FIGS. 1 and 2, a pacifier 1 comprises a head part having an arched surface. No less than three openings 10 are disposed on the arched surface circumferentially. The openings 10 may be disposed deviating from the center of the head part. As one example, these openings 10 are disposed uniformly or non-uniformly. The openings 10 are closed in a natural state, while are open when a user is sucking the pacifier 1.

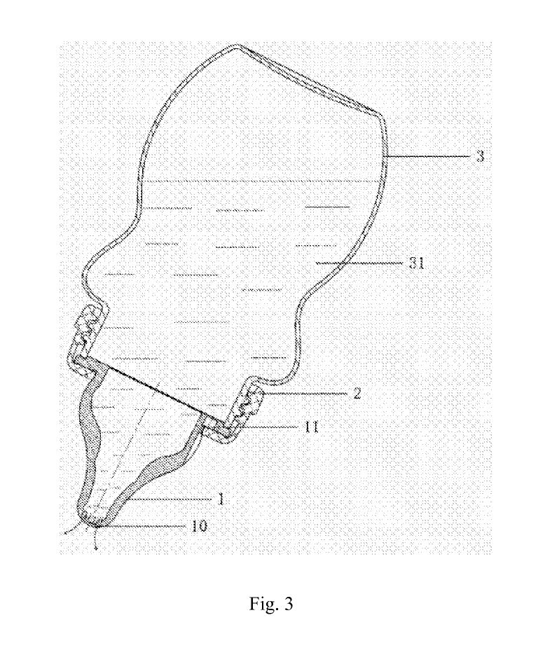

As is shown in FIG. 3, the pacifier 1 of the present invention is fitted with a screw cap 2 and then screwed onto a liquid container 3. When not in use, the openings 10 of the pacifier 1 can all be sealed naturally so as to avoid liquid leakage. When a user is sucking the pacifier 1, the suction causes the openings 10 to open. The liquid 31 within the container 3 flows out through the openings 10 disposed on the head part. Because the openings 10 are disposed on the arched surface, the liquid 31 flows out along the direction of the arched surface diffusely, so as to prevent the liquid 31 from rushing to the throat of the user directly. Such direct-flow milk feeding way may lead to choking. At the same time, gas can be fed into the container 3 through a pacifier air hole 11 to supplement pressure within the container 3, so as to prevent the liquid 31 from being unable to flow out due to the negative pressure within the container 3. When the user is not sucking the pacifier 1, the openings 10 become closed because of the effect of material elastic force, so as to prevent the liquid 31 from flowing out.

As is described in “Modern Surgery on Mammary Gland” edited by Yuemin CAO and Tao GONG, published by Hebei Science and Technology Press, Page 16: Section II: Mammary Gland Anatomy, II: Tissue and Structure of Mammary Gland: lactiferous sinus is arranged radially with the nipple being a center; lactiferous sinus becomes thinner again at the tip of the nipple and point-like openings are formed at the nipple. The multiple and circumferentially-arranged openings of the invention is to simulate the principle of breast milk ejection and apply a design of multiple breast milk ejection holes which are open and closed naturally. The liquid will flow out through the outer portions of the pacifier diffusely, so as to prevent the liquid 31 from flowing through the central portion of the traditional pacifier to rush to the throat of a baby directly. Thus, the probability of choking for the baby can be reduced.

Obviously, the above embodiments of the present invention are only the examples for illustrating clearly the present invention and should not be interpreted as any limitations to the present invention. Various variations or modifications can be made for one skilled in the art based on the above description. Here all of the embodiments can not be provided exhaustively. Obvious variations or modifications derived from the technical solution of the present invention will fall within the protection scope of the present invention.

1. A bionic pacifier comprising:
a head part having an arched surface;
a plurality of I-shaped openings disposed on the arched surface circumferentially,
wherein the openings extend along the radial direction of the head part and the extension lines of the openings intersect at the center of the head part.

2. The pacifier according to claim 1, wherein the openings are disposed circumferentially, deviating from the center of the head part.

3. The pacifier according to claim 2, wherein the openings are disposed uniformly.

4. The pacifier according to claim 2, wherein the number of the openings is no less than three.

5. The pacifier according to claim 3, wherein the number of the openings is no less than three.

6. The pacifier according to any claim 1, wherein the openings are closed in a natural state and open when the user is sucking the pacifier.

7. The pacifier according to claim 2, wherein the openings are closed in a natural state and open when the user is sucking the pacifier.

8. The pacifier according to claim 3, wherein the openings are closed in a natural state and open when the user is sucking the pacifier.

9. The pacifier according to claim 4, wherein the openings are closed in a natural state and open when the user is sucking the pacifier.

10. The pacifier according to claim 5, wherein the openings are closed in a natural state and open when the user is sucking the pacifier.
